(19) United States
(12) Patent Application Publication
(10) Pub. No.: US 2005/0158474 A1
(43) Pub. Date: Jul. 21, 2005

(54) Paint sampling system

(76) Inventor: Scott A. Brandt, Overland Park, KS (US)

Correspondence Address: ERICKSON & KLEYPAS, L.L.C., 800 W. 47TH STREET, SUITE 401, KANSAS CITY, MO, 64112, US

(21) Appl. No.: 10/757,920

(22) Filed: Jan. 15, 2004

(51) Int. Cl. B05D 1/00

(52) U.S. Cl. 427/401

(57) ABSTRACT

A method of distributing sample quantities of paint comprises distributing to paint retailers relatively small quantities of tinting base in bottles having a removable applicator head and a removable seal between the applicator head and the bottle. Upon selection of a color by a consumer, the retailer removes the applicator head and seal from the bottle, adds and mixes the required colorant, and reattaches the applicator head and seal. The consumer takes the sample to the surface to be painted, removes the applicator head, removes the seal from the applicator head and reattaches the applicator head to the bottle before applying a sample quantity of paint to the wall to be painted. After applying the paint, the consumer can remove and clean the applicator head, reinsert the seal in the applicator head and reattach the applicator head with the seal to the bottle.

### BACKGROUND OF THE INVENTION

The present invention relates to a system and method to facilitate the sampling of paint colors on a surface to be painted.

Selecting a color to paint a room can become a time consuming and relatively expensive experience. Paint swatches provided by the paint supply retailer are frequently used by the consumer to narrow down the potential colors to be selected. The consumer typically takes a few swatches, or a book of swatches to the wall or surface to be painted, to view the selected colors in the light and surroundings where the wall or surface is located. After selecting one or more colors from the swatches, the customer returns to the retailer and obtains samples, often one sample at a time, of the colors selected.

Currently the smallest container of paint, and therefore the smallest sample, that most retailers provide is a quart of paint, at a current average price of $10.00 per quart. These quart containers generally comprise the traditional can for paint with a flat, resealable, metal lid and are filled with a quart of a tinting base. Various tinting bases are available to provide various types of finishes, such as flat, satin, eggshell, semi-gloss and gloss. Using a tinting system, the retailer then adds metered amounts of selected pigments or tint coloring to the base to obtain the selected color and finish. This process is typically performed on a tinting machine specifically designed and programmed to add the required amount of pigment or tint coloring to a container of a selected quantity of the tinting base to obtain the desired color. The tinting system will also typically shake or mix the container to evenly distribute the pigment throughout the base.

Along with the quart sample, the consumer may also have to buy a brush or other suitable paint applicator such as a brush or a roller (approximately $2.00 to $15.00), a paint can opener to facilitate opening of the can, a pail or paint tray into which the paint may be poured to assist in applying the sample (approximately $2.00 to $5.00), and materials to assist in cleaning the items used in applying the paint sample. For every color not selected, the remaining paint in the quart sample is generally wasted through disposal or indefinite storage. It is believed that many consumers will waste approximately two or more quarts of paint in attempting to select a color. The costs associated with current paint sampling procedures can easily exceed $30 to $50. There remains a need for a paint sampling system which results in less waste and is less expensive for the consumer.

### SUMMARY OF THE INVENTION

The present invention comprises a paint sampling system and method in which tinting base is supplied to paint retailers in relatively small disposable bottles, preferably plastic, each with a cap that includes a sponge type applicator which may selectively be brought into contact with the contents of the bottle to permit the contents of the bottle to flow through the applicator. The bottles preferably are filled with the tinting base by the paint manufacturer and the filled bottles are then shipped to the retailer for display. Once a consumer selects a color to be sampled, the retailer tints or colors the tinting base using a standard tinting system, programmed to tint tinting bases in quantities as small as that provided in the bottle. The consumer then takes the sample bottle to the surface to be painted, places the contents of the bottle in contact with the applicator and then applies a selected quantity of the paint sample on the surface to be painted to assist in making a determination as to the color to be used.

The cap for the bottle also preferably includes an applicator cap to cover the applicator after use, to permit the unused quantity of the sample to be saved for later use. For example, the sample bottle containing the color selected could be saved for later use in touching up the painted surface.

Objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is an exploded, perspective view of a paint sample bottle used in the paint sampling system and method of the present invention.

FIG. 2 is a cross-sectional view of the paint sample bottle taken along line 2-2 of FIG. 1.

FIG. 3 is a process diagram illustrating the steps of the paint sampling system and method.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

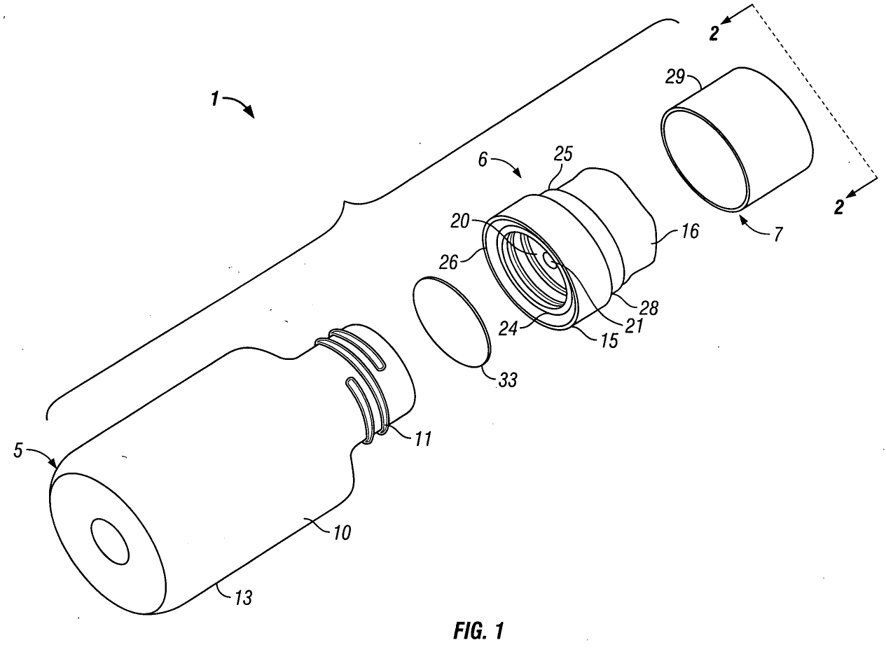

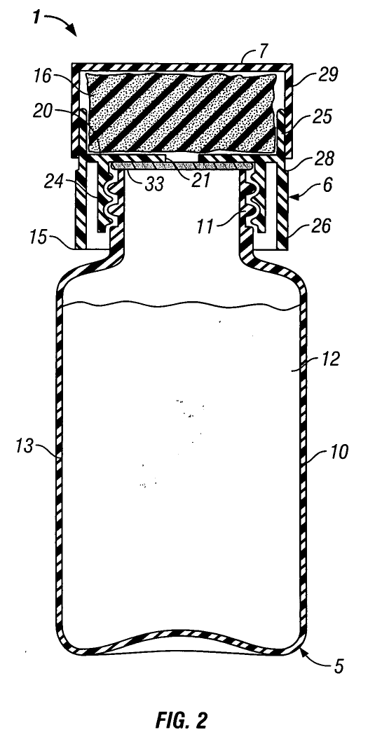

Referring to the drawings in more detail, FIGS. 1 and 2 show a paint sampler 1 which may be used in the paint sampling system and method of the present invention. The sampler 1 is of the type which is sold as a squeeze bottle with a sponge applicator head as marketed by Dharma Trading Co. at www.dharmatrading.com. The sampler 1 includes a bottle 5, a sponge applicator head 6 and a cap 7.

The bottle 5 includes a reservoir 10 and a threaded neck or spout 11, and is preferably formed from a relatively flexible plastic. The reservoir 10 is generally cylindrical and preferably sized to hold approximately eight ounces of a tinting base and colorant or tint 12. A circumferential wall 13 of the reservoir 10 is sufficiently thin to permit squeezing of the bottle 5. The threaded neck 11 is preferably approximately 1¼ inches in diameter with a thread formed on the outer surface thereof. The neck 11 is preferably sufficiently thick to resist radial or axial flexing.

The sponge applicator head 6 is designed to screw onto the threaded neck 11 of bottle 5. The sponge applicator head 5 includes an applicator head base 15 and a cylindrical applicator pad 16. The applicator pad 16 is preferably formed from a sponge or sponge-like material. The applicator head base 15 is preferably formed from a relatively rigid plastic and includes a circular head wall 20 with a paint dispensing hole 21 formed centrally therein. The paint dispensing hole 21 is sized to permit paint to readily flow therethrough, and in a preferred embodiment is approximately ¼ inch in diameter.

The applicator head base 15 further includes an internally threaded female receiver 24, an applicator pad retaining collar 25 and a applicator head skirt 26. The female receiver 24 extends below the head wall 20 (toward the reservoir 10) in axial alignment with and around the paint dispensing hole 21 and is sized to threadingly receive the threaded neck 11 of the bottle 5.

The applicator pad retaining collar 25 generally extends above the applicator head wall 20 (away from the reservoir 10) and in axial alignment with and around the paint dispensing hole 21. The collar 25 is sized slightly large in diameter and shorter than the applicator pad 16. The cylindrical applicator pad 16 is glued onto an upper surface of the head wall 20, within the collar 25 and across the paint dispensing hole 21. A portion of the applicator pad 16 extends above the collar 25.

The applicator head skirt 26 extends below the head wall 20 in spaced relation around the female receiver 24. A shoulder 28 is formed on the outer surface of applicator head skirt 26 and forms a stop against which a lower end of the cap 7 may abut. The cap 7 is also preferably formed from a relatively rigid plastic like the applicator head 6 and is designed to cover the applicator pad 16 when not in use. The inner diameter of a cap sidewall 29 is sized to fit snugly over the outer surface of the retaining collar 25 to form a friction fit when covering the applicator pad 16.

A circular sealing pad or disc 33 is positioned within the female receiver 24 against an inner or lower surface of the head wall 20 in covering relation to the paint dispensing hole 21. The sealing pad 33 is preferably formed from a waterproof foam type material which is flexible and resilient. The sealing pad 33 is sized slightly greater than the inner diameter of the internal threads of the receiver 24 so that it may be pressed into the receiver and held therein. When the applicator head 6 is screwed tightly onto the neck 11 of bottle 5, the upper surface of the neck 11 engages and compresses the periphery of the sealing pad 20 between it and the inner surface of the head wall 20. The sealing disc or member 33 is sized to completely cover the opening or outlet in the neck 11 of bottle 5 and forms a leakproof seal between the contents of the bottle 5 and the applicator pad 16.

When it is desired to apply the contents of the bottle 5 using the applicator pad 16, the cap 7 is removed from the applicator head 6 and the applicator head 6 is removed from the bottle 5, the sealing pad 33 is then removed from the female receiver 24 and the applicator head 6 is then screwed back onto the neck 11 of bottle 5. The contents of the bottle 5 may then flow through the paint dispensing hole 21 in the applicator head base 15 and into contact with the applicator pad 16. The bottle 5 may be squeezed to facilitate the transfer a sufficient quantity of the contents of the bottle 5 into the applicator pad 16 to fully load or saturate the applicator pad 16. The applicator pad 16 is then pressed against and moved across a surface to be painted to transfer paint from the applicator pad 16 to the surface to be painted.

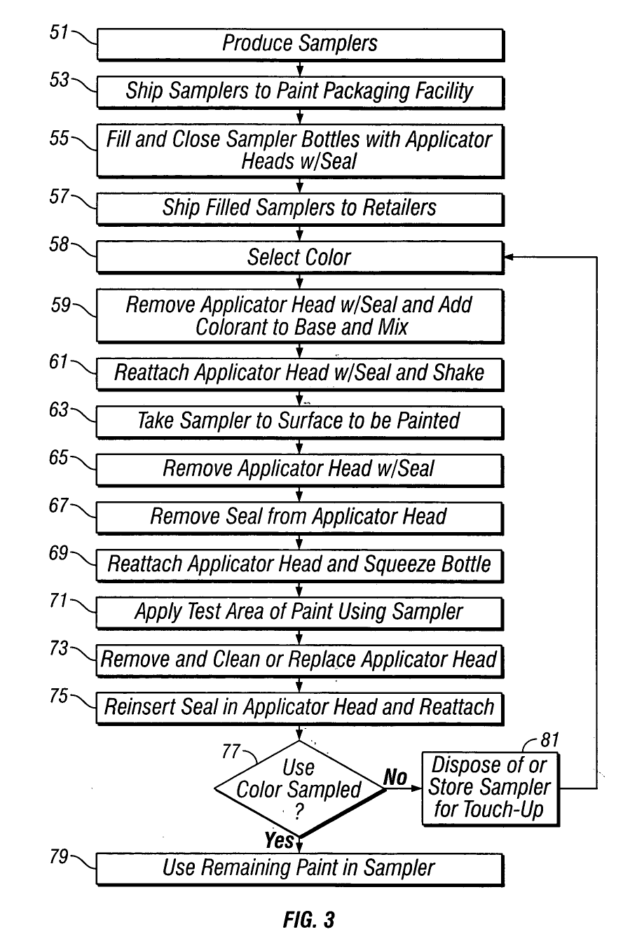

As discussed previously, the paint sampler 1 is particularly well adapted for use in the paint sampling system and method which is shown schematically in FIG. 3. In a preliminary step 51, paint samplers 1, including bottles 5, sponge applicator heads 6 (including sealing discs 33) and caps 7, are produced or acquired at a manufacturing plant. In a second step 53, the samplers 1 are shipped to a paint packaging facility. At step 55 the bottles 5 are filled at the paint packaging facility with selected quantities of tinting bases, which in the preferred embodiment is approximately eight ounces, and the applicator heads 6 (with sealing discs 33 positioned therein) and the caps 7 are secured to the bottles 5 forming a sealed paint sampler 1 containing tinting base.

The sealed and filled paint samplers 1 are then shipped at step 57 to paint retailers. As used herein, the phrase paint retailer is generally intended to include any entity or business that sells to the end user or consumer and not to a reseller. A retailer may include a specialty paint store, a hardware store that sells paint, an internet based business selling paint. A paint manufacturer may be considered a retailer to the extent it sells directly to the end consumer.

The paint retailers preferably display or store a selected quantity of the paint samplers 1 in close proximity to a paint tinting system on its premises, such as a Highland Automatic Fast Tint 5000 Colorant Dispenser. When a consumer requests a sample of paint of a selected color at step 58, the sponge applicator head 6 (with sealing disc 33) and cap 7 of a sampler 1 are removed from the bottle 5 and the bottle 5 is placed in a specified position in the paint tinting system to add the required tint or colorant to obtain the selected color at step 59. The selected color is entered into the paint tinting system along with an indication of the quantity of tinting base to be colored. The paint tinting system then adds the appropriate amount of tints or colorants to the bottle 5 to obtain the color selected by the consumer. Once the colorant is added, the applicator head 6 (with sealing disc 33) and cap 7 are reapplied to the bottle to seal the contents therein at step 61. The tinting system also preferably shakes the contents of the bottle 5 to mix or uniformly distribute the colorant throughout the tinting base. It is foreseen that mixing means other than shaking could be utilized.

The consumer then takes the sealed paint sampler 1 to the surface to be painted at step 63, removes the applicator head 6 and cap 7 at step 65, then removes the sealing pad 33 from between the neck 11 and head wall 20 of applicator head base 15 at step 67. The consumer then reattaches the applicator head 6 to the bottle at 69 and squeezes the bottle 5 to force paint out of the bottle reservoir 10 and through the paint dispensing hole 21 in applicator head base 15 and into applicator pad 16. The consumer then paints a portion of the surface using the paint sampler 1 at step 71.

Once the consumer paints an area on the surface large enough to assist in determining how the color will actually look in association with its environment, the consumer can place the cap 7 over the applicator head 6 to prevent the head from accidently painting other surfaces and to slow down the rate at which the paint in the applicator pad 16 dries out. Alternatively or subsequently, the consumer may remove the applicator head 6 from the bottle 5 and clean the applicator head 6 including the applicator pad 16 at step 73 to remove any paint therefrom, reinsert the sealing pad 33 into the receiver 24 and then reattach the head 6 to the bottle 5 to seal the paint therein as generally indicated at step 75. The consumer may also separately purchase replacement applicator heads 6 with sealing pads 33 and caps 7 to seal the bottle 5 and its remaining contents to avoid having to clean the applicator head 6.

After the sample section of paint dries, the consumer then must make a decision as to whether to paint the entire surface with the color sampled at step 77. If the consumer decides at decision step 77 to use the color sampled, the consumer can then use the remaining paint in the sampler 1 to paint the surface at step 79. The sampler 1 may be particularly well adapted for painting around the edges of the surface to be painted or around trim if painting a wall with windows doors or the like. Alternatively, the sampler 1 with the color selected may be saved for later use in touching up sections of the painted surface. In a preferred embodiment, the consumer may separately purchase replacement applicator heads 6 and caps 7 if the applicator pads 16 are not adequately cleaned out before storing.

If at the decision step 77 the consumer decides not to use the color sampled, the consumer may dispose of the sampler 1 or save it for some other purpose or use at step 81, such as touching up the surface painted. The consumer then returns to the retailer and the steps are generally repeated beginning at step 58 with the consumer selecting another color. It is to be understood that the consumer can obtain multiple samplers 1 with different colors at any visit to the retailer, to simultaneously apply and compare the colors to be sampled.

The system and process discussed above has been described with reference to the actions taken by each of the individuals or entities involved in the process. However, the process may also be described with reference to any one entity or individual in the process, such as a paint manufacturer, a paint distributor or an entity facilitating the process. With reference to a paint manufacturer, the manufacturer may order the production and shipment of the paint samplers to its production or packaging facility at steps 51 and 53. The manufacturer then fills and closes the sampler bottles 5 with the applicator heads 6 at step 55 and ships the filled bottles 5 to its paint retailers at step 57.

The manufacturer typically does not directly perform the remaining steps of the process, rather the manufacturer provides instructions to the paint retailers and consumers on completing each of the remaining steps of the process as described above. The instructions are typically provided in writing but could be in the form of a live demonstration or an audio-visual work, such as an instructional video. The process may be similarly described with reference to the steps taken and instructions provided by a paint distributor or a broker or facilitator.

The system and process described reduces the amount of paint that must be purchased by a consumer in making a color selection and should reduce the amount of unused sample paint that must be disposed of in land fills or the like. In addition, since no separate pan, tray, brush or applicator is needed for use in applying paint with the sampler, there are fewer items to clean further reducing the amount of paint utilized and the amount washed down drains into the wastewater treatment system. It is also believed that the energy requirements associated with producing the plastic paint samplers 1 are less than that associated with manufacturing steel paint cans thereby conserving resources in manufacturing the containers.

It is to be understood that while certain forms of the present invention have been illustrated and described herein, it is not to be limited to the specific forms or arrangement of parts described and shown. For example, it is foreseen that the sealing disc or sealing member 33 could be removably attached to the neck or spout 11 of the bottle 5 instead of being carried within the receiver 24 of the applicator head 6.

1. A method of distributing sample quantities of paint comprising the steps of:
a) filling paint sample bottles with a selected quantity of a tinting base;
b) removably attaching a paint applicator head across an outlet of each of said bottles; said paint applicator head including an applicator base and a paint applicator, said paint applicator mounted on said applicator base on a side opposite said outlet of said bottle, said applicator having an opening extending therethrough in communication with said paint applicator;
c) removably positioning a sealing member between each of said bottles and said applicator heads to extend across said outlet of each of said bottles
d) supplying a paint retailer with a quantity of said bottles filled with the selected quantity of tinting base each having a paint applicator head and a sealing member attached thereto.

2. The method as in claim 1 wherein the step of filling said bottles with said tinting base comprises filling said bottles with approximately eight ounces of said tinting base.

3. The method as in claim 1 wherein said paint applicator comprises a sponge pad.

4. The method as in claim 1 further comprising the steps of:
a) removing said paint applicator head from a selected bottle and adding one or more colorants to said tinting base in said selected bottle to produce a sample of paint of a color selected by a consumer; and
b) reattaching said paint applicator head to said selected bottle with said sealing member extending across said bottle outlet.

5. The method as in claim 4 further comprising the steps of:
a) removing said applicator head from said selected bottle;
b) removing said sealing member from across said bottle outlet;
c) reattaching said applicator head to said selected bottle;
d) squeezing said bottle to urge a portion of said sample of paint through said bottle outlet and said opening in said applicator base and into said applicator; and
e) applying said sample of paint to a surface to be painted with said applicator.

6. A method of distributing sample quantities of paint comprising the steps of:
a) filling paint sample bottles with a selected quantity of a tinting base;
b) removably attaching a paint applicator head to a neck of each of said bottles; said paint applicator head including an applicator base, a paint applicator and a sealing member, said applicator base including a headwall with a receiver formed on a first side for connecting to said neck on said bottle, said paint applicator mounted on said base on a side of said headwall opposite said receiver and said headwall having an opening extending therethrough in communication with said receiver and said paint applicator; said removable seal being positioned within said receiver in covering relationship with said opening in said headwall such that when said applicator head is removably attached to said bottle said sealing member is positioned between said bottle neck and said headwall of said paint applicator head;
c) supplying to a paint retailer a quantity of said bottles filled with the selected quantity of tinting base and having paint applicator heads attached thereto.

7. The method as in claim 6 wherein the step of filling said bottles with said tinting base comprises filling said bottles with approximately eight ounces of said tinting base.

8. The method as in claim 6 wherein said paint applicator comprises a sponge pad.

9. The method as in claim 6 further comprising the steps of:
a) removing said paint applicator head from a selected bottle and adding one or more colorants to said tinting base in said selected bottle to produce a sample of paint of a color selected by a consumer; and
b) reattaching said paint applicator head to said selected bottle with said sealing member positioned between said bottle neck and said headwall of said paint applicator base.

10. The method as in claim 6 further comprising the steps of:
a) removing said applicator head from said selected bottle;
b) removing said sealing member from between said bottle neck and said headwall of said paint applicator base;
c) reattaching said applicator head to said selected bottle;
d) squeezing said bottle to urge a portion of said sample of paint through said bottle neck and said opening in said headwall and into said applicator; and
e) applying said sample of paint to a surface to be painted with said. applicator.

11. A method of distributing sample quantities of paint comprising the steps of:
a) filling paint sample bottles with a selected quantity of a tinting base;
b) removably attaching a paint applicator head across an outlet of each of said bottles; said paint applicator head including an applicator base and a paint applicator, said paint applicator mounted on said applicator base on a side opposite said outlet of said bottle, said applicator having an opening extending therethrough in communication with said paint applicator;
c) removably positioning a sealing member between each of said bottles and said applicator heads to extend across said outlet of each of said bottles;
d) supplying a paint retailer with a quantity of said bottles filled with the selected quantity of tinting base each having a paint applicator head and a sealing member attached thereto;
e) coloring said tinting base to a color selected by a consumer by removing said paint applicator head from a selected bottle and adding one or more colorants to said tinting base in said selected bottle to produce paint of the color selected by the consumer;
f) reattaching said paint applicator head to said selected bottle with said sealing member extending across said bottle outlet and between said bottle and said applicator head;
g) removing said sealing member from between said bottle and said applicator head prior to applying the paint of the color selected by the consumer to a surface.

12. The method as in claim 11 wherein the step of filling said bottles with said tinting base comprises filling said bottles with approximately eight ounces of said tinting base.

13. The method as in claim 11 wherein said paint applicator comprises a sponge pad.

14. A method of distributing sample quantities of paint comprising the steps of:
a) filling paint sample bottles with a selected quantity of a tinting base;
b) removably attaching a paint applicator head across an outlet of each of said bottles; said paint applicator head including an applicator base and a paint applicator, said paint applicator mounted on said applicator base on a side opposite said outlet of said bottle, said applicator having an opening extending therethrough in communication with said paint applicator;
c) removably positioning a sealing member between each of said bottles and said applicator heads to extend across said outlet of each of said bottles;
d) supplying a paint retailer with a quantity of said bottles filled with the selected quantity of tinting base each having a paint applicator head and a sealing member attached thereto;
e) instructing the paint retailer to color said tinting base to a color selected by a consumer by removing said paint applicator head from a selected bottle and adding one or more colorants to said tinting base in said selected bottle to produce paint of the color selected by the consumer; and instructing the paint retailer to then reattach said paint applicator head to said selected bottle with said sealing member extending across said bottle outlet and between said bottle and said applicator head; and
g) instructing said consumer to remove said sealing member from between said bottle and said applicator head prior to applying the paint of the color selected to a surface.

15. The method as in claim 14 wherein the step of filling said bottles with said tinting base comprises filling said bottles with approximately eight ounces of said tinting base.

16. The method as in claim 14 wherein said paint applicator comprises a sponge pad.
